(19) United States
(12) Patent Application Publication
(10) Pub. No.: US 2013/0019842 A1
(43) Pub. Date: Jan. 24, 2013

(54) FLOW RATE ESTIMATION FOR PIEZO-ELECTRIC FUEL INJECTION

(71) Applicants: Gregory Matthew Shaver, Lafayette, IN (US); Christopher Allen Satkoski, Carmel, IN (US)

(72) Inventors: Gregory Matthew Shaver, Lafayette, IN (US); Christopher Allen Satkoski, Carmel, IN (US)

(73) Assignee: PURDUE RESEARCH FOUNDATION, West Lafayette, IN (US)

(21) Appl. No.: 13/515,204

(22) PCT Filed: Dec. 13, 2010
(86) PCT No.: PCT/US10/60110

§ 371 Date: Jun. 11, 2012

Related U.S. Application Data
(60) Provisional application No. 61/285,835, filed on Dec. 11, 2009.

(51) Int. Cl. F02M 51/06

(52) U.S. Cl. 123/478; 701/103

(57) ABSTRACT

Improving tradeoffs between noise, fuel consumption, and emissions in future diesel engines are facilitated by the development of increasingly flexible fuel injection systems which can deliver more complex injection profiles. Piezoelectric injectors have the ability to deliver multiple, tightly spaced injections in each cycle. Closed-loop control is useful for this technology, and is assisted by on-line estimation of the injected fuel flow rate to be realized. Estimator results are compared against both open-loop simulation and experimental data for a variety of profiles at different rail pressures, and show improvement, particularly for more complex multi-pulse profiles. Internal states of the estimator are used to evaluate pulse-to-pulse interaction phenomena. Some embodiments include the use of estimations of actual transient fuel pulses, and the use of such estimations to achieve closed-loop control of the quantity of fuel injected in a pulse, and the dwell time between adjacent fuel pulses.

### CROSS REFERENCE TO RELATED APPLICATION

This application claims the benefit of priority to U.S. Provisional Patent Application Ser. No. 61/285,835, filed Dec. 11, 2009, titled FLOW RATE ESTIMATION FOR PIEZO-ELECTRIC FUEL INJECTION, incorporated herein by reference.

### FIELD OF THE INVENTION

Various embodiments of the inventions pertain to the analysis and control of a transient flow of a liquid or gas, and in some embodiments to the pulsed injection of fuel into an engine.

### BACKGROUND OF THE INVENTION

In order for diesel engines to continue to meet tightening emissions regulations and to further reduce fuel consumption and noise, greater flexibility in the fuel injection process is helpful. More complex injection profiles coupled with advanced modes of combustion can result in significant reductions in emissions and fuel consumption. Piezoelectric injectors are faster and more powerful than solenoid injectors, allowing direct, hydraulically amplified movement of the injector needle. A piezo-electric injector allows faster needle motion, resulting in better air entrainment, spray development, and injection velocity.

Direct needle control can also allow multiple, tightly spaced injections. This may be useful for controlling spatial fuel distribution and managing the heat release profile—allowing reductions in noise. Enhanced control also has utility in improving the ultra-clean and efficient technology of low-temperature combustion.

One reason that it is difficult to deliver accurate fueling in a desired profile is that it is difficult to directly measure fuel flow on a pulse-to-pulse basis. If, instead, a fuel flow estimate could be obtained, closed-loop control strategies could be used to ensure proper fueling delivered in the desired profile. Electronically controlled solenoid injectors generally run open-loop, referring to maps to meter the appropriate fuel.

Various embodiments of the inventions discussed herein provide improvements with regards to the estimation of fuel flow.

### SUMMARY OF THE INVENTION

Some embodiments of the present invention pertain to estimation of the quantity and timing of discrete injections of fuel injected during operation of an engine.

One aspect of the present invention pertains to method of controlling an internal combustion engine. Some embodiments include an electronic controller operating a piezo-electrically actuated fuel injector. Other embodiments include actuating the injector, and measuring the actuation voltage. Yet other embodiments include using the measurement of voltage and calculating an estimated electrical signal by the electronic controller.

Another aspect of the present invention pertains to an electronic controller operably connected to an electrically actuatable fuel injector, and a predetermined desired transient input of fuel. Other embodiments include transmitting a first injector control signal and flowing a first transient input of fuel to the engine. Yet other embodiments include measuring an input parameter to the fuel injector during the first transient input of fuel, calculating an estimated transient input of fuel using the measured input parameter, and comparing the estimated transient input of fuel to the desired transient input of fuel.

Yet another aspect of the present invention pertains to a method of controlling a liquid or gas injection system, including actuating an electronically controlled liquid or gas injector with a first electrical signal including a pair of electrical pulses separated by a dwell time. Still other embodiments include measuring an input to the electric injector actuator and using the measured input and calculating an estimated pair or a larger pulse train of injected liquid or gas pulses.

It will be appreciated that the various apparatus and methods described in this summary section, as well as elsewhere in this application, can be expressed as a large number of different combinations and subcombinations. All such useful, novel, and inventive combinations and subcombinations are contemplated herein, it being recognized that the explicit expression of each of these combinations is excessive and unnecessary.

### BRIEF DESCRIPTION OF THE DRAWINGS

FIG. 1 shows the effect of commanding fuel pulses too closely together.

FIG. 2 shows the effect of rail pressure on injector dynamics.

FIG. 3 shows the effect of a prior pulse on pulse dynamics.

FIG. 4 shows operating principles of a piezoelectric fuel injector.

FIG. 5 shows structure for the open loop simulation model of a piezoelectric fuel injector according to one embodiment of the present invention.

FIG. 6 shows a structure for state estimation in piezoelectric fuel injector with feedback according to one embodiment of the present invention.

FIG. 7 shows simulation results for a single pulse profile.

FIG. 8 shows estimator results for a single pulse profile.

FIG. 9 shows simulation results for a double pulse profile.

FIG. 10 shows estimator results for a double pulse profile.

FIG. 11 shows simulation results for a multiple pulse profile.

FIG. 12 shows estimator results for a multiple pulse profile.

FIG. 13 shows simulation results for a varying pulse size profile.

FIG. 14 shows estimator results for a varying pulse size profile.

FIG. 15 shows estimator predicting pulse behavior when the commanded dwell is reduced.

FIG. 16 shows estimator predicting pulse behavior at two separate rail pressures.

FIG. 17 shows estimator predicting pulse behavior for an extended first pulse.

FIG. 18 shows a modeled needle lift with experimentally determined 1/R_{need}.

FIG. 19 shows a modeled needle lift for a shorter commanded dwell.

FIG. 20 shows a modeled needle lift for the same commanded TTL at two rail pressures.

FIG. 21 shows a modeled needle lift for a nominal commanded TTL and extended first pulse.

FIG. 22(a) shows a system structure according to one embodiment of the present invention.

FIG. 22(b) shows a control loop structure for a fuel injector

FIG. 22(c) shows a control method according to another embodiment of the present invention.

FIG. 23 shows a delayed integration technique for cycle-to-cycle flow rate estimation according to one embodiment of the present invention.

FIG. 24 shows an example of delayed time integration for an injection pulse according to one embodiment of the present invention.

TABLE 1
Model Parameters

| VARIABLE | DEFINITION |
|---|---|
| Vᵢₙ | commanded voltage |
| L | driver inductance |
| I | driver current |
| R | driver resistance |
| Vₛ | piezo stack voltage |
| N | num. discs in piezo stack |
| A_{disc} | area of piezo disc |
| D | piezo disc charge density |
| g₃₃ | piezo disc charge density |
| ε₃₃^{X} | permittivity of piezo discs (const. stress) |
| t | thickness of piezo disc |
| s₃₃^{D} | piezo disc compliance (const. elec. field) |
| d | piezoelectric coefficient |
| P_{bv} | injector body pressure |
| C_{bv} | injector body liquid capacitance |
| Pᵣₐᵢₗ | rail pressure |
| Rᵣₐᵢₗ | fluid resistance, rail-injector body |
| Pᵤᵥ | needle upper volume pressure |
| R_{cv} | fluid resistance, check valve |
| P_{cyl} | cylinder pressure |
| Rₜₒₜₐₗ(x) | fluid resistance, out of injector |
| x | needle lift |
| Pₗᵥ | needle lower pressure volume |
| u | top link displacement |
| z | check valve displacement |
| y | bottom link displacement (during link disconnection) |
| ω_{iof} | injector-out flow |

### DESCRIPTION OF THE PREFERRED EMBODIMENT

For the purposes of promoting an understanding of the principles of the invention, reference will now be made to the embodiments illustrated in the drawings and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates. At least one embodiment of the present invention will be described and shown, and this application may show and/or describe other embodiments of the present invention. It is understood that any reference to “the invention” is a reference to an embodiment of a family of inventions, with no single embodiment including an apparatus, process, or composition that should be included in all embodiments, unless otherwise stated.

The use of an N-series prefix for an element number (NXX.XX) refers to an element that is the same as the non-prefixed element (XX.XX), except as shown and described thereafter. As an example, an element 1020.1 would be the same as element 20.1, except for those different features of element 1020.1 shown and described. Further, common elements and common features of related elements are drawn in the same manner in different figures, and/or use the same symbology in different figures. As such, it is not necessary to describe the features of 1020.1 and 20.1 that are the same, since these common features are apparent to a person of ordinary skill in the related field of technology. Although various specific quantities (spatial dimensions, temperatures, pressures, times, force, resistance, current, voltage, concentrations, wavelengths, frequencies, heat transfer coefficients, dimensionless parameters, etc.) may be stated herein, such specific quantities are presented as examples only, and further, unless otherwise noted, are approximate values, and should be considered as if the word “about” prefaced each quantity. Further, with discussion pertaining to a specific composition of matter, that description is by example only, and does not limit the applicability of other species of that composition, nor does it limit the applicability of other compositions unrelated to the cited composition.

Various embodiments of the present invention pertain to estimation of the quantity and timing of one or more pulses of fuel injected into an engine. However, various other embodiments of the present invention may pertain to the estimation of the quantity and timing of pulses of any liquid or gas into systems other than engines, especially in those systems in which the pulse timings are short enough to be influenced by the transient response and electromechanical dynamics of the pulse-producing equipment. Although some of the results presented herein were obtained with a diesel engine and diesel injectors, such information is by way of example only, and various embodiments of the present invention are applicable to any engine to which fuel is provided include diesel, spark ignition, gas turbines, and rotary (Wankel) engines.

In some embodiments, an estimation method is described that permits an estimation of fuel injected into an engine, especially in those cases in which any sensor being used to measure fuel flow does not exist or have sufficient high speed response or high frequency response to accurately measure the injection event.

Further, some embodiments of the present invention pertain to those systems in which the electrically actuated injector has electrical, mechanical, and/or hydraulic dynamics that should be accounted for when operated in a pulsed manner. As one example, some internal combustion engines are operated with a train of discrete fuel injections in which the dwell (off time) between adjacent pulses is so short that the electro-hydromechanical injector has not achieved a steady state after the control signal of a first pulse ends, and before a second pulse is initiated. In such applications, the estimation methods disclosed herein, especially those which take into account the dynamics of the fuel injector, can more accurately estimate the quantity and timing of fuel that was actually delivered to the engine, which can be useful in correlating the control signals to a desired engine output (such as an emission from the engine exhaust, the noise created during operation, the fuel consumption of the engine, torque or power provided by the engine, or related engine operating parameters.

One embodiment of the present invention pertains to the use of a mathematical model of a fuel injector to predict a transient fuel flow of fuel injected into an engine. Some embodiments of the present invention utilize the results of a simulation model of a piezoelectric injector that has been analyzed and shown to predict the injection rate, piezo stack voltage, and piezo stack current of the prototype injector at two different rail pressures. Simplified driver circuits, linear piezo response, and rigid body assumptions were utilized. Some or all of these predictions can be used to calculate errors during implementation, and these errors can be corrected by closed-loop control.

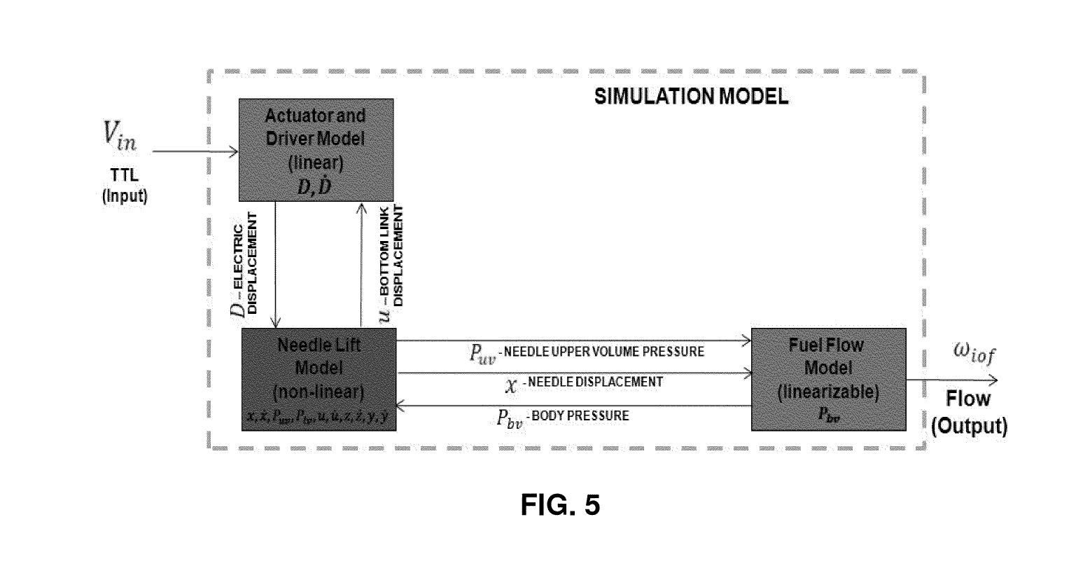

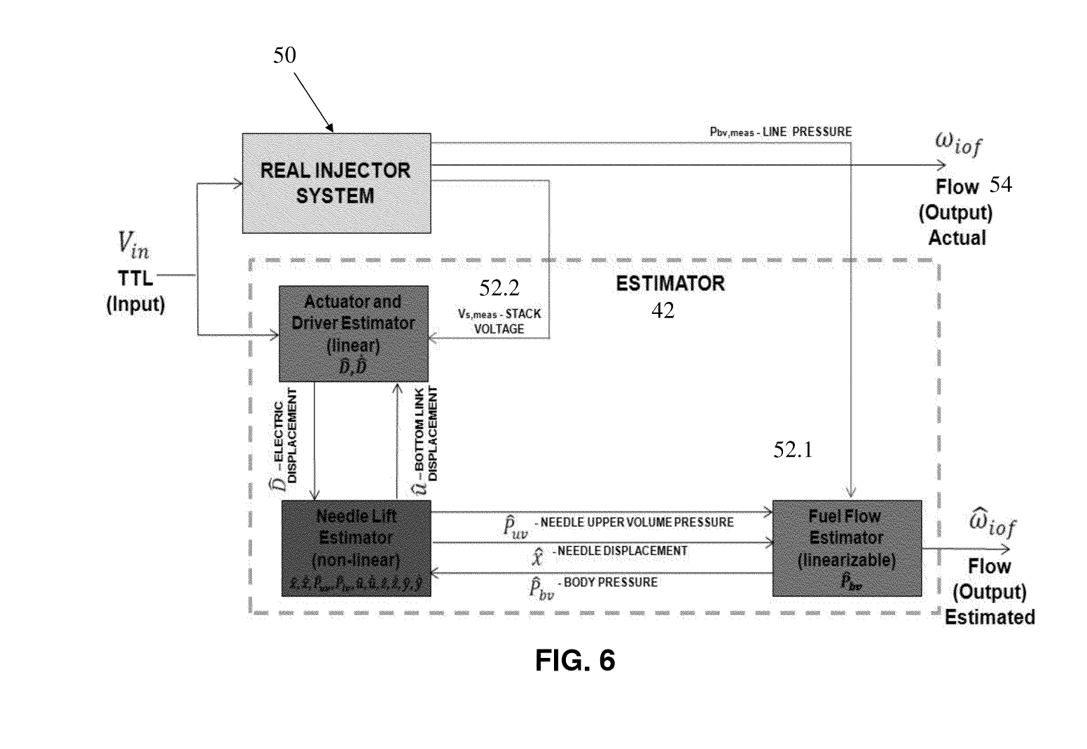

One embodiment of an estimation scheme for a piezoelectric actuated fuel injector is discussed here (FIG. 6 and Eq. (3.32) through (3.37)). The estimator utilizes feedback, such as from the sensors of piezo stack voltage and line (internal) fuel pressure, which are provided as non-limiting examples. A full non-linear model is divided into sub-models (FIG. 3.2 and Eq. (3.1) through (3.6)). Linear state-space simplifications are derived for the driver and actuator as well as the fuel flow model. These linearized state space models are used to calculate estimator feedback gains to achieve the desired closed-loop response. Various embodiments of the present invention permit closed loop control of the quantity of fuel provided in one or more short duration, discrete pulses, and also to provide a corrected dwell time between adjacent pulses in a pulse train. These estimator feedback gains are applied to the non-linear equations in the model to generate an estimator (FIG. 6). The estimator performance is compared to the simulation model (FIG. 5) and experimental data and shows improvement, particularly for multiple pulse profiles. The estimated needle lift is used to analyze pulse-to-pulse phenomena that occurs with tightly spaced pulses. A hypothesis is presented which divides the needle lift vs. flow resistance relationship into distinct regimes, and ties the pulse-to-pulse behavior to the regime transitioning that occurs with complex profiles.

The flow rate estimation strategy is utilized in some embodiments for cycle-to-cycle computation. High speed data acquisition captures and stores important estimation variables such as the stack voltage and body pressure during the injection period, and computation of state variables is delayed to more efficiently utilize the processor over the entire cycle. With this cycle-to-cycle estimation of flow being available as feedback, a closed loop control algorithm is developed for control of quantities and realized dwell times for tightly spaced, multiple pulse profiles. A simplified “two pulse approximation” model is developed and coupled with a modified discrete integral controller, and with some reformulation, is shown to have reduced or no steady-state error and preferred overdamped, asymptotic behavior to prevent pulse bleed during control action.

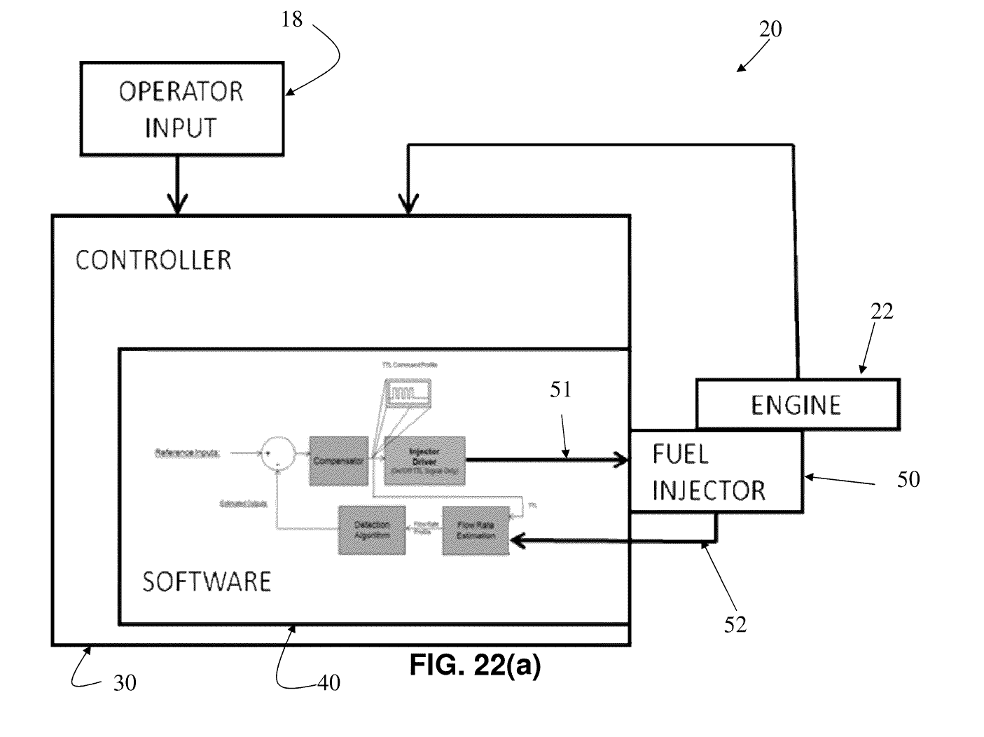

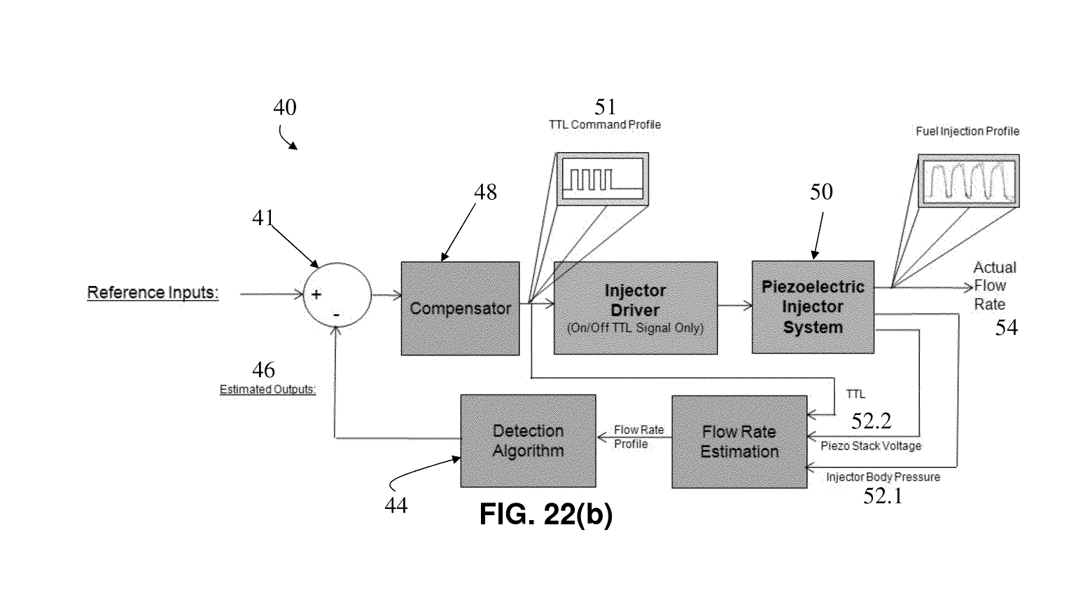

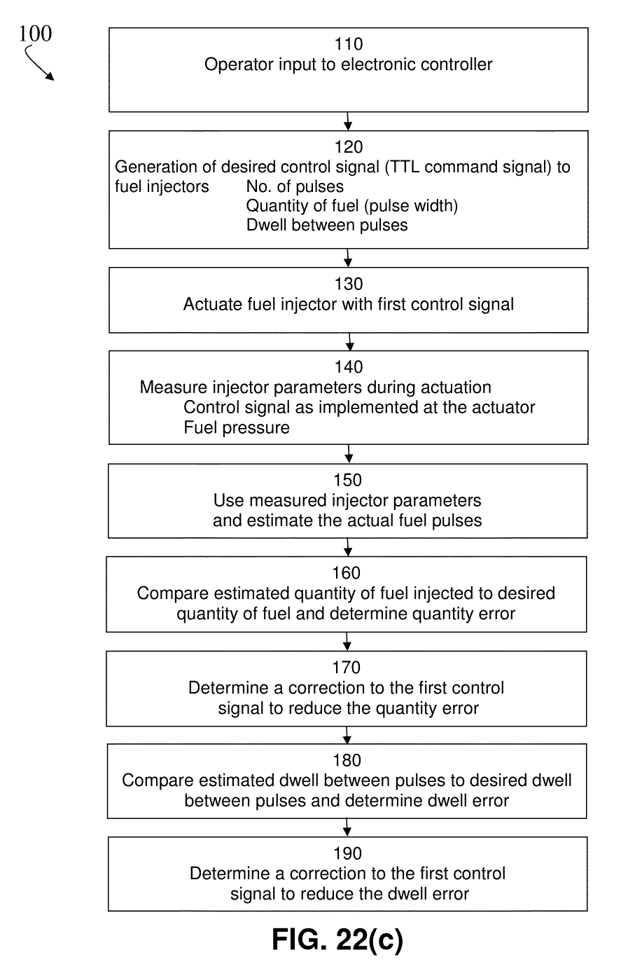

FIG. 22(a) shows a system 20 according to one embodiment of the present invention. A controller 30, such as an engine control unit (ECU) or full authority digital electronic control (FADEC) is provided an operator input 18 that initiates some desired operation of engine 22 (shown as act 110 in FIG. 22(c)). As examples, operator input 18 could be a throttle input from an operator of a diesel engine, or a throttle position for a gas turbine engine. It is appreciated that controller 30 receives various other inputs, including sensors measuring ambient conditions (not shown), and various operational parameters from engine 22 (shown by a feedback arrow). Examples of sensed engine parameters include torque, speed, operating temperatures, and exhaust parameters, such as oxygen content or temperature.

Controller 30 receives the various operator inputs and other sensor inputs, and preferably digitizes these signals for operations to be performed by one or more algorithms representing software 40 stored within memory. Various algorithms within software 40 determine how to convert the operator input into a control scheme, the scheme including the injection of a transient input of fuel, such as one or more discrete pulses of fuel (as represented by act 120 in FIG. 22(c). As is typical of computers (one type of controller 30), various software outputs are converted back to driving signals (which may be in analog form), and these driving signals are provided to engine 22 (as represented by act 130 of FIG. 22(c)). Although what is shown and described is a transient input of fuel comprise a pair of discrete pulses, this is by way of example only and not to be construed as limiting. For example, the transient input can be of any shape, including a single discrete quantity of fuel. Further, the shape of a pulse need not be similar to a square wave, but can be of any shape including similar to ramp, sawtooth, triangular, sinusoidal, boot or any other shape.

FIG. 22(a) shows that an output such as an injector driver control signal 51 is provided to an electrically actuated fuel injector 50. Injector 50 receives fuel under pressure, and converts the control signal to physical operation, which results in the injection of fuel into a manifold or combustion chamber (including, by way of example, gas turbine combustion systems including wave rotors) for subsequent combustion within engine 22.

FIG. 22(b) shows additional components within algorithm 40. FIG. 22(c) indicates various acts performed in one version of algorithm 40. In one embodiment, algorithm 40 includes an estimator that uses sensory data from a fuel injector to estimate the actual transient flow of fuel resulting from a particular control signal. In yet another embodiment, algorithm 40 includes a summing junction 41 that determines an error signal between a reference input and estimated output 46. The summing junction 41 calculates a difference, which is fed forward through a compensator that adjusts the characteristics of the error signal to produce a TTL command profile 51 that is subsequently provided to a suitable injector driver. The output of the driver is then applied to an actuation mechanism of fuel injector 50 (as represented by act 130).

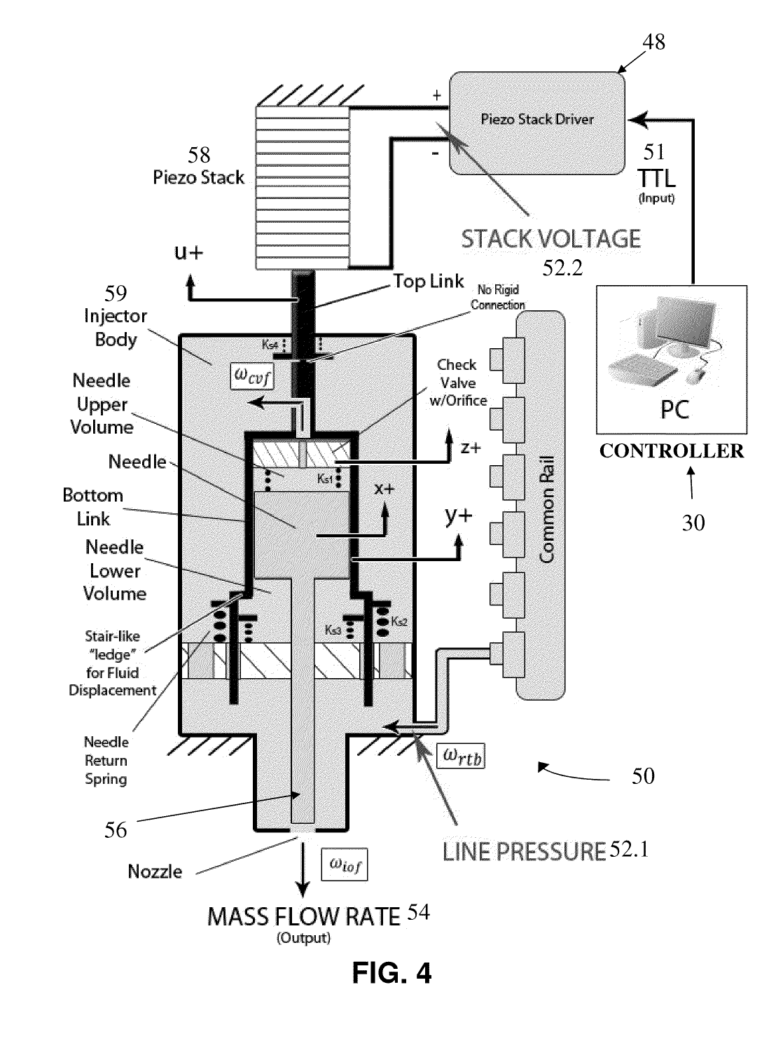

In some embodiments, fuel injector 50 converts the signal from driver 48 into physical operations. These operations change the position or other state of components within injector 50, and result in the providing of an actual train of fuel pulses 54 provided for combustion within engine 22. Further discussion of the conversion dynamics from signal to fuel flow output for one particular fuel injector will be described later with regards to FIG. 4.

Various input parameters to fuel injector 50 are provided to a flowrate estimation algorithm 42 within software 40 (as represented by act 140). Examples of these inputs include injector body pressure 52.1 and piezo-electric stack voltage 52.2. Further, control signal 51, representative of the desired fuel pulse, is further fed to estimator 42. Estimator 42 then uses the various inputs to estimate the actual pulse of fuel (as represented by act 150).

Although what is shown and described is the providing of a particular pressure and voltage, it is understood that estimator 42 can be provided with any measurable inputs or outputs from injector 50. Other examples include measurements of current (for those electrical actuators that can be modeled in terms of current flow). Further, although what is shown and described herein is measurement of pressure 52.1 as provided to the fuel injector at its location on engine 22, it is appreciated that the pressure could be measured at various locations, such as along the conduit providing pressure from the common rail (as shown in FIG. 4). Further, it is appreciated that the pressure input could be pressure within the rail, or pressure provided to the rail from a fuel pump, or pressure calculated based on operational parameters of the fuel system (such as pump voltage and speed, or an expected map of pump performance, as examples). The various estimation methods shown herein pertain to voltage and pressure measurements at the injector, but it appreciated that the estimator simulation models could be adapted and configured for measurement of these inputs, or other inputs, at other inputs, at other locations, with some possible changes in the fidelity of the estimations.

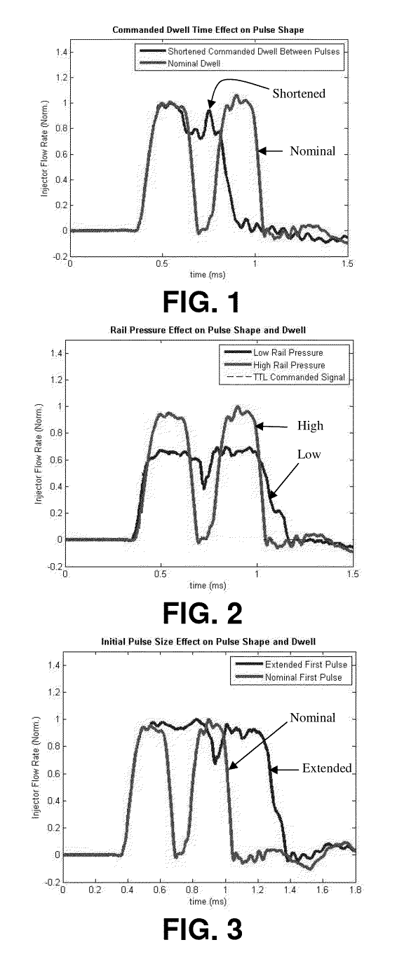

Piezoelectric injectors can deliver many, tightly spaced pulses per cycle. If pulses are commanded too closely together (i.e. if the commanded dwell between pulses is too short), they will ‘bleed’ into one another, as is shown in FIG. 1, which includes the results of two experiments with different commanded dwell times.

In addition to the dependence on commanded dwell (FIG. 1), the actual realized pulse dwell time (as opposed to commanded) is also dependent on other factors as well, including rail pressure and the length of the previous pulse. This makes generating repeatable pulse dwell times difficult to generalize and hard to empirically map for all possible operating points. This is illustrated by FIG. 2, which shows the result of identical input voltage signals being delivered to the injector, but with two different rail pressures.

One effect shown in FIG. 2 is the reduced peak flow rate for the low pressure case, and also shown is the extended pulse width that occurs at lower pressures. The two pulses bleed together into one single pulse. Another effect occurs when changing the pulse width of a previous pulse.

Even though the commanded dwell time and on-time for the second pulse are identical for the cases in FIG. 3, changing the on-time of the first pulse has changed what was two distinct pulses into one. In summary, FIG. 1 through 3 illustrate that the piezoelectric injector is a dynamic, coupled system. As will be shown, estimation of the injector needle position is another way to predict the flow rate of these and other complex profiles.

With accurate flow rate estimates, closed-loop control can be implemented for real-time, on-line correction of the commanded on/off times to force the output to converge to the desired profile.

An estimator according to one embodiment of the present invention utilizes a derived physically-based model of a direct acting piezoelectric fuel injector 50 to synthesize a nonlinear fuel flow rate estimator utilizing piezo stack voltage 52.2 and the line pressure 52.1 (see FIG. 4) as feedback signals. Although what is shown and described is a specific type of piezo-electrically operated fuel injector, the present invention is not so limited and contemplates embodiments in which other types of electrically actuated fuel injectors are utilized, modeled, and for which transient fuel quantity and dwell times are estimated.

FIG. 4 is a schematic representation of an electro-hydromechanical fuel injector 50 according to one embodiment of the present invention. A stack driver 48 receives an input signal 51 from controller 30, and modifies that signal for compatibility and effect to a voltage 52.2 applied across piezo stack 58. Although an electrical actuator including a piezo-electric device is disclosed, the present invention includes other types of electrical actuators including, as examples, actuators having magnetic effect upon a hydromechanical valve (such as solenoids).

Piezo stack 58 converts the driving voltage 52.2 to a displacement input on a hydromechanical unit (injector body) 59. This displacement input from the piezo stack drives one or more hydromechanical components, which in turn changed the position of a hydromechanical valve (needle) 56. The location of the end of valve 56 from a nozzle establishes a flow area fed by fuel within injector body 59. A mass flowrate 54 of one or more pulses of fuel is provided to engine 20.

This injector 50 according to one embodiment of the present invention uses hydraulic amplification to transmit energy from the piezoelectric stack 58 to the needle 56. The area ratio of the stair-like ledge, shown in FIG. 4, and the bottom of the needle 56 are sized to turn a relatively short piezo stack stroke (approx. 90 μm) into a longer needle stroke (approx. 200 μm). It is understood that the apparatus shown in FIG. 4 is by way of example only, and some embodiments of the present invention contemplate any type of injector mechanism.

A TTL (Transistor-Transistor Logic) signal is sent to the piezo stack driver as the input to the system. However, it is understood that the analysis and description provided herein pertaining to discrete pulses is also applicable to any type of voltage signal. As one example, the algorithm described herein can also be used when the voltage input (or current input) to the electric actuator is continuously variable. Especially in those situations in which the changing nature of the electrical input is so quick that the mechanical dynamics of the injector are insufficiently slow to keep up.

The TTL triggers the driver to charge the piezo stack up to 1000 V. As charge flows to the piezoelectric discs, they expand, causing downward motion of the top link and bottom link. Although what is shown and discussed is the generation and measurement of a voltage signal to a piezo stack, it is understood that the present invention is not so limited, and contemplates the use of other types of actuators as well as, and further can include the measurement of quantities other than the stack voltage in order to assess the control signal input to the electrically actuated fuel injector.

When the bottom link moves down, the stair-like ledge displaces liquid in the needle lower volume, raising the pressure below the needle. Eventually, the pressure across the needle becomes large enough for upward needle movement, pushing fluid out of the needle upper volume through the check valve orifice into the injector body. The needle uncovers the nozzle holes and fuel flows out of the injector.

As the injector driver is triggered to discharge, the piezo stack contracts, but because in some embodiments there is no solid connection between the top and bottom link, the piezo stack cannot pull upwards on the bottom link, lifting the needle. The needle lower volume pressure has remained above the needle upper volume pressure during injection because of the area ratio across the needle. This increased pressure pushes upwards on the bottom link, lowering the needle lower volume pressure and closing the needle. This pushing action continues until the needle lower volume pressure reduces to its pre-injection pressure at which point the needle return spring will close the needle. As the closing action occurs, the check valve may pop open, allowing fuel to fill the needle upper volume more quickly, improving the closing speed.

Some equations for estimator synthesis will be described below. Although an approach according to one embodiment will be described, the present invention is not so limited and contemplates modifications to this model, as well as other models.

The injector system can be thought of as three distinct, dynamically coupled systems: actuator and driver system; fuel flow system; and needle lift system.

The piezoelectric actuator driver for this system is modeled as an input voltage (commanded), Vᵢₙ, in series with a resistance, inductance, and the piezo stack.

Vᵢₙ=Lİ+RI+Vₛ (2.1)

L is the effective inductance, I is the current, R is the effective resistance, and Vₛ is the voltage across the piezo stack.

One state for a piezoelectric actuator is the electric displacement (charge density−charge/area), D. The electric displacement can be related to the current with the following equations:

$$\begin{matrix}\frac{I}{N {A}_{disc}} = \dot{D} & ( 2.2 ) \\ \frac{\dot{I}}{N {A}_{disc}} = \ddot{D} & ( 2.3 )\end{matrix}$$

where N is the number of discs in the stack and A_{disc} is the area of each disc. The relationships can be coupled with Eq. (2.1) to create an equation relating input voltage to piezoelectric charge density.

Vᵢₙ=LA_{disc}N\ddot{D}+RA_{disc}N\dot{D}+Vₛ (2.4)

The constitutive relations for piezoelectric material can be utilized under the assumptions of constant property and frequency independence. They relate electric field, strain, stress, and charge density in piezoelectric materials. Manipulation of two of these equations yields the following relationships used in this model for stack voltage and displacement:

$$\begin{matrix}{V}_{s} = \frac{{g}_{33} t}{{A}_{disc}} F ( t ) + \frac{t}{{ε}_{33} x} D & ( 2.5 ) \\ u = \frac{{s}_{33}^{D} tN}{{A}_{disc}} F ( t ) - {g}_{33} tND & ( 2.6 )\end{matrix}$$

where

$${g}_{33} = \frac{1}{{ɛ}^{x}} \cdot d ,$$

d is the piezoelectric coefficient, _{ε}x is the permittivity of the material at constant stress, t is the thickness of each disc, F(t) is the force acting on the material, u is the stack elongation, and s₃₃^{D} is the material compliance under constant electric displacement.

The injector has a variety of fluid flow paths, as its hydro-mechanical operating principle typically includes small amounts of fuel flowing into and out of the needle upper volume. The line-pressure (see FIG. 4) can be measured by a transducer right before fuel enters the body of the injector.

Pressure and flow dynamics are modeled using a bulk-modulus flow relationship:

$$\sum {ω}_{in} - \sum {ω}_{out} = \frac{d {V}_{0}}{d t} + \frac{{V}_{0}}{β} \frac{d P}{d t} \qquad ( 2.7 )$$

where ωᵢₙ is the volumetric flow into a volume, ωₒᵤₜ is the volumetric flow out of a volume, V₀ is the mean volume, β is the bulk modulus of liquid, and P is the pressure.

Assuming that the pressure drop between the inlet from the rail and nozzles is negligible, the pressure inside of the injector will be approximated to be the measured line pressure. With this assumption, the state of the model which represents the line pressure, called body pressure (P_{bv}), has dynamics represented in the following equation, derived from Eq. (2.7):

$${\dot{P}}_{bv} = \frac{1}{{C}_{bv}} ( {ω}_{rtb} + {ω}_{cvf} - {ω}_{iof} ) \qquad ( 2.8 )$$

where ω_{rtb} is the rail-to-body flow, ω_{cvf} is the flow through the check valve, ω_{iof} is the injector out flow, and

$${C}_{bv} = \frac{{v}_{bv}}{β}$$

is the fluid capacitance of the body volume. Using an orifice flow equation, the individual flows can be modeled.

$$ω = {C}_{d} {A}_{0} \sqrt{\frac{2}{ρ} Δ P} . \qquad ( 2.9 )$$

where ΔP is the pressure drop against the resistance, ω is the flow through the orifice, C_{d} is the coefficient of discharge, A₀ is the orifice area, and ρ is the liquid density. Simplification of this equation comes from grouping terms into a flow resistance, where

$$R ω = \sqrt{Δ P} where R = \sqrt{\frac{ρ}{2 {C}_{d}^{2} {A}_{0}^{2}}} \qquad ( 2.10 )$$

A dynamic equation for the injector body pressure is:

$${\dot{P}}_{bv} = \frac{{( {P}_{rail} - {P}_{bv} )}^{1 / 2}}{{R}_{rail} {C}_{bv}} + \frac{{( {P}_{uv} - {P}_{bv} )}^{1 / 2}}{{R}_{cv} {C}_{bu }} - \frac{{( {P}_{bv} - {P}_{cyl} )}^{1 / 2}}{{R}_{total} ( x ) {C}_{bv}} \qquad ( 2.11 )$$

where Pᵣₐᵢₗ is the common rail pressure, Pᵤᵥ is the needle upper volume pressure, P_{cy}I is the cylinder pressure, Rᵣₐᵢₗ is the resistance between the common rail and the injector, R_{cv} is the resistance across the check valve, and Rₜₒₜₐₗ(x) is the variable flow resistance out of the nozzle, which is a function of the injector needle lift, x. Some embodiments of the present invention include methods and/or apparatus that implement Eq. (2.11) or one of its equivalents.

The needle lift system can be described by non-linear hydro-mechanical equations which represent the force and displacement from the stack forcing the bottom link into the needle lower volume, raising the pressure, and lifting the needle. These dynamics are generally non-linear. The needle rests against the seat, and when the needle lower volume pressure is high enough—the needle lifts. The needle lift system is embedded in the injector such that measurements of any model states may not be available. The non-linear needle system dynamic model is incorporated directly into the estimator. This sub-model contains the states of needle displacement, x, needle velocity, \dot{x}, needle upper volume pressure, Pᵤᵥ, needle lower volume pressure Pₗᵥ, top link displacement, u, top link velocity, \dot{u}, check valve displacement z, check valve velocity ż, bottom link displacement during disconnection, y, and bottom link velocity during disconnection, \dot{y}.

The three sub-models briefly described above can be summarized by the following nonlinear state model equations. The actuator stack model will be represented by the states x₁=[D \dot{D}]^{T}, the fuel flow model by the states x₂=[P_{by}], and the needle lift system by x₃=[x \dot{x} Pᵤᵥ Pₗᵥ u \dot{u} z ż y \dot{y}]^{T}. f₁, f₂, f₃, g₁, g₂ and g₃ are known functions of states and inputs to determine state derivatives or model outputs.

$$\begin{matrix}ACTUATOR DRIVER MODEL & \\ {\dot{x}}_{1} = {f}_{1} ( {x}_{1} , {u}_{1} ) = {f}_{1} ( [ \begin{matrix}D \\ \dot{D}\end{matrix} ] , [ \begin{matrix}{V}_{i n} \\ u\end{matrix} ] ) & ( 2.12 ) \\ {y}_{1} = [ \begin{matrix}{V}_{s} \\ D\end{matrix} ] = {g}_{1} ( {x}_{1} , {u}_{1} ) = {g}_{1} ( [ \begin{matrix}D \\ \dot{D}\end{matrix} ] , [ \begin{matrix}{V}_{i n} \\ u\end{matrix} ] ) & ( 2.13 ) \\ FUEL FLOW MODEL & \\ {\dot{x}}_{2} = {f}_{2} ( {x}_{2} , {u}_{2} ) = {f}_{2} ( [ {P}_{bv} ] , [ \begin{matrix}{P}_{cyl} \\ x \\ {P}_{rail} \\ {P}_{uv}\end{matrix} ] ) & ( 2.14 ) \\ {y}_{2} = [ \begin{matrix}{P}_{bv} \\ {ω}_{iof}\end{matrix} ] = {g}_{2} ( {x}_{2} , {u}_{2} ) = {g}_{2} ( [ {P}_{bv} ] , [ \begin{matrix}{P}_{cyl} \\ x \\ {P}_{rail} \\ {P}_{uv}\end{matrix} ] ) & ( 2.15 ) \\ NEEDLE LIFT SYSTEM MODEL & \\ {\dot{x}}_{3} = {f}_{3} ( {x}_{3} , {u}_{3} ) = {f}_{3} ( [ \begin{matrix}x \\ \dot{x} \\ {P}_{uv} \\ {P}_{lv} \\ u \\ \dot{u} \\ z \\ \dot{z} \\ y \\ \dot{y}\end{matrix} ] , [ \begin{matrix}{P}_{bv} \\ D\end{matrix} ] ) & ( 2.16 ) \\ {y}_{3} = [ \begin{matrix}x \\ {P}_{uv} \\ u\end{matrix} ] = {g}_{3} ( {\dot{x}}_{3} , {u}_{3} ) = {g}_{3} ( [ \begin{matrix}x \\ \dot{x} \\ {P}_{uv} \\ {P}_{lv} \\ u \\ \dot{u} \\ z \\ \dot{z} \\ y \\ \dot{y}\end{matrix} ] , [ \begin{matrix}{P}_{bv} \\ D\end{matrix} ] ) & ( 2.17 )\end{matrix}$$

The full set of modeling equations is shown above. The coupling between these sub-system models is shown in FIG. 5. A list of states is P_{bv}, Pₗᵥ, x, \dot{x}, u, z, ż, y, \dot{y}, D and \dot{D}.

The injector system can be into three sub-models, as summarized in Eq. (2.12) through (2.17) and as shown in FIG. 5. FIG. 6 shows an estimator strategy according to one embodiment of the present invention.

Some linear full-order estimation strategies use linear system models to synthesize an estimator. The injector model is generally non-linear; however, when broken into sub-models the actuator/driver model is substantially linear and the fuel flow model can be approximated by a linearized model. Feedback correction of state estimates can be applied directly to the linear actuator/driver equations as well the non-linear dynamic equations in the fuel flow model. The needle lift model can be run open loop, with estimates of electric displacement, \dot{D}, and body volume pressure, P_{bv}, generated as shown in FIG. 6. It is appreciated that the present invention contemplates linearization of any of the models shown above.

The input to the real system and estimator according to one embodiment (FIG. 6) is the TTL signal that triggers the actuator driver, although the present invention contemplates any type of signal for triggering the actuator driver. Available measurements for stack voltage and line pressure are additional inputs to the estimator. The Output of the estimator is the estimated fuel flow.

Note that the feedback is applied to the sub-model estimators where the measurement is directly relevant—pressure for the fuel flow estimator. The inherent coupling between the sub-models is retained.

The design of a linear full-order estimator can start with a linear system in state-space form.

\dot{x}=Ax+Bu y=Cx+Du (3.1)

where x is the state vector, A is the state matrix, B is the input matrix, u is the input vector, y is the output vector, C is the output matrix and D is the direct transmission matrix.

A model representing the real dynamic system can be defined as the following:

{circumflex over (\dot{x}=A\hat{x}+Bu (3.2)

where \hat{x} is the model estimate of the state and A, B and u are known. Defining the error to be

$$\tilde{x} {=}^{Δ} x - \hat{x} \qquad ( 3.3 )$$

results in

{dot over (\tilde{x}=\dot{x}−{dot over (\hat{x}=A\tilde{x} (3.4)

This indicates that the error converges to 0 if A is Hurwitz. In order to influence the rate at which the estimate converges to the actual value, feedback can be added so that:

{dot over (\hat{x}=A\hat{x}+Bu+L(y−C\hat{x}) (3.5)

where l is the estimator gain vector

L=[l₁,l₂, . . . lₙ]^{T} (3.6)

This results in error dynamics described by

{dot over (\tilde{x}=(A−LC):\tilde{x} (3.7)

with a characteristic equation:

det[sI−(A−LC)]=0 (3.8)

The estimator gains can be chosen by appropriately placing the desired poles for the needed estimator response.

Estimator design begins with a state-space representation of the dynamics. Combining and rearranging Eq. (2.4), (2.5), and (2.6) gives the following differential equation:

$$\ddot{D} = - \frac{R}{L} \dot{D} - ( \frac{{g}_{333}^{2} t}{{s}_{333}^{D} {LA}_{disc} N} + \frac{t}{{ε}_{33}^{X} {LA}_{disc} N} ) D - \frac{{g}_{33} t}{{LA}_{disc}^{2} {N}^{2} {s}_{33}^{D}} u + \frac{1}{{LA}_{disc} N} {V}_{i n} \qquad ( 3.9 )$$

Note that defining the states of the system as x₁ₐ=D and x_{1b}=\dot{D}, and the inputs as u₁ₐ=u and u_{1b}=V₁ₙ. a state-space representation is created of the form \dot{x}₁=A₁x₁+B₁u₁.

$$[ \begin{matrix}{\dot{x}}_{1 a} \\ {\dot{x}}_{1 b}\end{matrix} ] = [ \begin{matrix}0 & 1 \\ - ( \frac{{g}_{33}^{2} t}{{s}_{33}^{D} {LA}_{disc} N} + \frac{t}{{ε}_{33}^{X} {LA}_{disc} N} ) & - R / L\end{matrix} ] [ \begin{matrix}{x}_{1 a} \\ {x}_{1 b}\end{matrix} ] + [ \begin{matrix}0 & 0 \\ - \frac{{g}_{33} t}{{LA}_{disc}^{2} {N}^{2} {s}_{33}^{D}} & \frac{1}{{LA}_{disc} N}\end{matrix} ] [ \begin{matrix}{u}_{1 a} \\ {u}_{1 b}\end{matrix} ] \qquad ( 3.10 )$$

The output is the stack voltage as described in Eq. (2.5). This can be written in terms of the defined states and inputs of the form y₁=C₁x₁+D₁u₁ where y₁ₐ=Vₛ.

$$[ {y}_{1 a} ] = [ t / {ε}_{33}^{X} 0 ] [ \begin{matrix}{x}_{1 a} \\ {x}_{1 b}\end{matrix} ] + [ \begin{matrix}{g}_{33} t / {A}_{disc} & 0\end{matrix} ] [ \begin{matrix}{u}_{1 a} \\ {u}_{1 b}\end{matrix} ] \qquad ( 3.11 )$$

Note that this output equation differs from Eq. (2.13) and excludes D. When designing the estimator, the output of the actuator/driver stack sub-model are specified to be consistent with the measured variable, in this case the piezo stack voltage. Defining an observer gain matrix as L₁=[L₁ₐL_{1d}]^{T}, the characteristic equation for the dynamics of the estimate error is given.

det[sI−(A₁−L₁C₁)]=0 (3.12)

Solving for the characteristic polynomial,

$${s}^{2} + ( \frac{R}{L} + \frac{{L}_{1 a} t}{{ε}_{33 }^{X}} ) s + ( \frac{{L}_{1 a} Rt}{{ε}_{33}^{X} L} + \frac{t}{{ε}_{33}^{X} {LA}_{disc} N} + \frac{{g}_{33}^{2} t}{{LA}_{disc}^{2} {N}^{2} {s}_{33}^{D}} + \frac{{L}_{1 b} t}{{ε}_{33}^{X}} ) . \qquad ( 3.13 )$$

Selection of the desired poles of the closed-loop estimator system is in some embodiments an iterative process to achieve the desired tracking and filtering tradeoff, and depends on the noise content of the feedback signal. In consideration of the noise level for the stack voltage feedback, an approximate time constant, τₐ, will be chosen to be 1/200 of 1 ms (5 μs). This time scale can be smaller than the time scale of even the smallest injection event. However, it is recognized that the present invention contemplates any manner of choosing the appropriate time constants.
For τ≈−1/(Real Part of Pole), two real poles are placed at −200,000. This creates the following desired characteristic polynomial.

s²+400,000s+4·10¹⁰. (3.14)

Solving,

L₁ₐ=19 and

L_{1b}=6·10⁵

Following the same process, the fuel flow system described in Eq. (2.11) will be put into state-space form, but first will be linearized. Eq. (2.11) essentially shows three flow terms affecting the pressure of the injector body:

$${\dot{P}}_{bv} = \frac{{( {P}_{rail} - {P}_{bv} )}^{.5}}{{R}_{rail , lin} {C}_{bv}} + \frac{{( {P}_{uv} - {P}_{bv} )}^{.5}}{{R}_{cv , lin} {C}_{bv}} - \frac{{( {P}_{bv} - {P}_{cyl} )}^{.5}}{{R}_{total , lin} ( x ) {C}_{bv}} \qquad ( 3.15 )$$

The first term is the flow from the rail (ω_{rtb}), the second is the flow from the needle upper volume (ω_{cvf}), and the third is the flow out of the injector (ω_{iof}). Linearization of these terms will require simplifying these relationships. A suitable operating pressure region can be picked, and a linear approximation of ω_{rtb} and ω_{cvf} can be made. The subscript lin denotes the linear slope of the pressure/flow relationship for each flow path.

ω_{iof} is a complex non-linear term. Not only is there a nonlinear relationship between the needle lift, x, and the fluid resistance out of the injector, R_{total(χ)}, but at any given resistance the flow is also non-linear. To simplify, it is recognized that the estimator is most useful when the needle is open and fuel is flowing, therefore a fully open needle position is chosen for this analysis.

Rearranging the equation gives:

$${\dot{P}}_{bv} = - ( \frac{1}{{R}_{rail , lin} {C}_{bv}} + \frac{1}{{R}_{cv , lin} {C}_{bv}} + \frac{1}{MIN [ {R}_{total , lin} ( x ) ] {C}_{bv}} ) {P}_{bv} + \frac{{P}_{rail}}{{R}_{rail , lin} {C}_{bv}} + \frac{{P}_{uv}}{{R}_{cv , lin} {C}_{bv}} + \frac{{P}_{cyl}}{MIN [ {R}_{total , lin} ( x ) ] {C}_{bv}} \qquad ( 3.16 )$$

A state of the fuel flow system is x₂ₐ=P_{bv}, the injector body volume pressure. With Pᵣₐᵢₗ, Pᵤᵥ, and P_{cyl} as external influences on the system, they are defined as inputs: u₂ₐ=Pᵣₐᵢₗ, u_{2b}=Pᵤᵥ, and u_{2c}=P_{cyl}. The 1-dimensional state-space model is created with the form \dot{x}=A₂x+B₂u.

$$[ {\dot{x}}_{2 a} ] = [ - ( \frac{1}{{R}_{rail , lin} {C}_{bv}} + \frac{1}{{R}_{cv , lin} {C}_{bv}} + \frac{1}{MIN [ {R}_{total , lin} ( x ) ] {C}_{bv}} ) ] [ {x}_{2 a} ] + [ \frac{1}{{R}_{rail , lin} {C}_{bv}} \frac{1}{{R}_{cv , lin} {C}_{bv}} \frac{1}{MIN [ {R}_{total , lin} ( x ) ] {C}_{bv}} ] [ \begin{matrix}{u}_{2 a} \\ {u}_{2 b} \\ {u}_{2 c}\end{matrix} ] \qquad ( 3.17 )$$

The output of the system is simply the state y₂ₐ=P_{bv}(x₂ₐ) and is written in form of y=C₂x+D₂u.

$$[ {y}_{2 a} ] = [ 1 ] [ {x}_{2 a} ] + [ \begin{matrix}0 & 0 & 0\end{matrix} ] [ \begin{matrix}{u}_{2 a} \\ {u}_{2 b} \\ {u}_{2 c}\end{matrix} ] \qquad ( 3.18 )$$

This output equation differs from Eq. (3.25) because the output is defined as the measured variable, in this case the body pressure, P_{bv}. Defining an observer gain matrix as L₂=[L₂ₐ], the characteristic equation for the dynamics of the error will be

det[sI−(A₂−C₂)]=0 (3.19)

or the characteristic polynomial

$$s + ( \frac{1}{{R}_{rail , l i n} {C}_{bv}} + \frac{1}{{R}_{cv , lin} {C}_{bv}} + \frac{1}{MIN [ {R}_{total , lin} ( x ) ] {C}_{bv}} ) + {L}_{2 a} = 0 \qquad ( 3.20 )$$

If the body pressure sensor tends to be noisy, a single, real, less aggressive pole selection can be made at −5000. The approximate time constant would be 200 μs. This results in a characteristic polynomial of

(s+5000) (3.21)

Solving, the estimator gain is l₂ₐ≈5

The estimate correction scheme in Eq. (3.5) can be utilized for correction in the actuator/driver sub-model. Estimator gains calculated from the linearized fuel flow sub-model, as outlined earlier in Sect. 3.3, are incorporated as shown in FIG. 6, where the non-linear output and state equations are used.

The actuator and stack model from Eq. (2.12) in Sect. 2.2 is corrected by the addition of the estimator gain and error.

$$\begin{matrix}{{x}^{\dot{\hat{}}}}_{1} = {f}_{1} ( {\hat{x}}_{1} , {u}_{1} ) + {L}_{1} ( {V}_{s , meas} - {V}_{s} ) = {f}_{1} ( [ \begin{matrix}\hat{D} \\ {D}^{\dot{\hat{}}}\end{matrix} ] , [ \begin{matrix}{V}_{i n} \\ \hat{u}\end{matrix} ] ) + [ \begin{matrix}{L}_{1 a} \\ {L}_{1 b}\end{matrix} ] [ {V}_{s , meas} - [ \begin{matrix}1 & 0\end{matrix} ] {g}_{1} ( [ \begin{matrix}\hat{D} \\ {D}^{\dot{\hat{}}}\end{matrix} ] , [ \begin{matrix}{V}_{i n} \\ \hat{u}\end{matrix} ] ) ] & ( 3.22 ) \\ {y}_{1} = [ \begin{matrix}{\hat{V}}_{s} \\ \hat{D}\end{matrix} ] = {g}_{1} ( {x}_{1} , {u}_{1} ) = {g}_{1} ( [ \begin{matrix}\hat{D} \\ {D}^{\dot{\hat{}}}\end{matrix} ] , [ \begin{matrix}{V}_{i n} \\ \hat{u}\end{matrix} ] ) & ( 3.23 )\end{matrix}$$

The fuel flow system from Eq. (2.14) is also corrected by the estimator gain and errors derived above.

$$\begin{matrix}{{x}^{\dot{\hat{}}}}_{2} = {f}_{2} ( {\hat{x}}_{2} , {u}_{2} ) + {L}_{2} ( {P}_{bv , meas} - {P}_{bv} ) = {f}_{2} ( [ {P}_{bv} ] , [ \begin{matrix}{P}_{cyl} \\ x \\ {P}_{rail} \\ Puv \\ x\end{matrix} ] ) + [ {L}_{2 a} ] ( {P}_{bv , meas} - {g}_{2} ( [ {\hat{P}}_{bv} ] , [ \begin{matrix}{P}_{cyl} \\ {\hat{R}}_{need} ( x ) \\ {P}_{rail} \\ {\hat{P}}_{uv }\end{matrix} ] ) ) & ( 3.24 ) \\ {y}_{2} = [ \begin{matrix}{\hat{P}}_{bw} \\ {\hat{ω}}_{iof}\end{matrix} ] = {g}_{2} ( {x}_{2} , {u}_{2} ) = {g}_{2} ( [ {\hat{P}}_{bv} ] , [ \begin{matrix}{P}_{cyl} \\ \hat{x} \\ {P}_{rail} \\ {\hat{P}}_{uv}\end{matrix} ] ) & ( 3.25 )\end{matrix}$$

The non-linear needle lift system (\hat{x}₃) is implemented directly as described in Eq. (2.16) without feedback.

$$\begin{matrix}{\dot{x}}_{3} = {f}_{3} ( {x}_{3} , {u}_{3} ) = {f}_{3} ( [ \begin{matrix}\hat{x} \\ {x}^{\dot{\hat{}}} \\ {\hat{P}}_{uv} \\ {\hat{P}}_{lv} \\ \hat{u} \\ {u}^{\dot{\hat{}}} \\ \hat{z} \\ {z}^{\dot{\hat{}}} \\ \hat{y} \\ {y}^{\dot{\hat{}}}\end{matrix} ] , [ \begin{matrix}{\hat{P}}_{bv} \\ \hat{D}\end{matrix} ] ) & ( 3.26 ) \\ {y}_{3} = [ \begin{matrix}\hat{x} \\ {\hat{P}}_{uv} \\ \hat{u}\end{matrix} ] = {g}_{3} ( {x}_{3} , {u}_{3} ) = {g}_{3} ( [ \begin{matrix}\hat{x} \\ {x}^{\dot{\hat{}}} \\ {\hat{P}}_{uv} \\ {\hat{P}}_{lv} \\ \begin{matrix}\hat{u} \\ \begin{matrix}{u}^{\dot{\hat{}}} \\ {u}^{\dot{\hat{}}}\end{matrix}\end{matrix} \\ \hat{z} \\ {z}^{\dot{\hat{}}} \\ \hat{y} \\ {y}^{\dot{\hat{}}}\end{matrix} ] , [ \begin{matrix}{\hat{P}}_{bv} \\ \hat{D}\end{matrix} ] ) & ( 3.27 )\end{matrix}$$

FIG. 6 and Eqs. (3.22) through (3.27) generally describe one proposed injector fuel flow rate estimator according to one embodiment of the present invention.

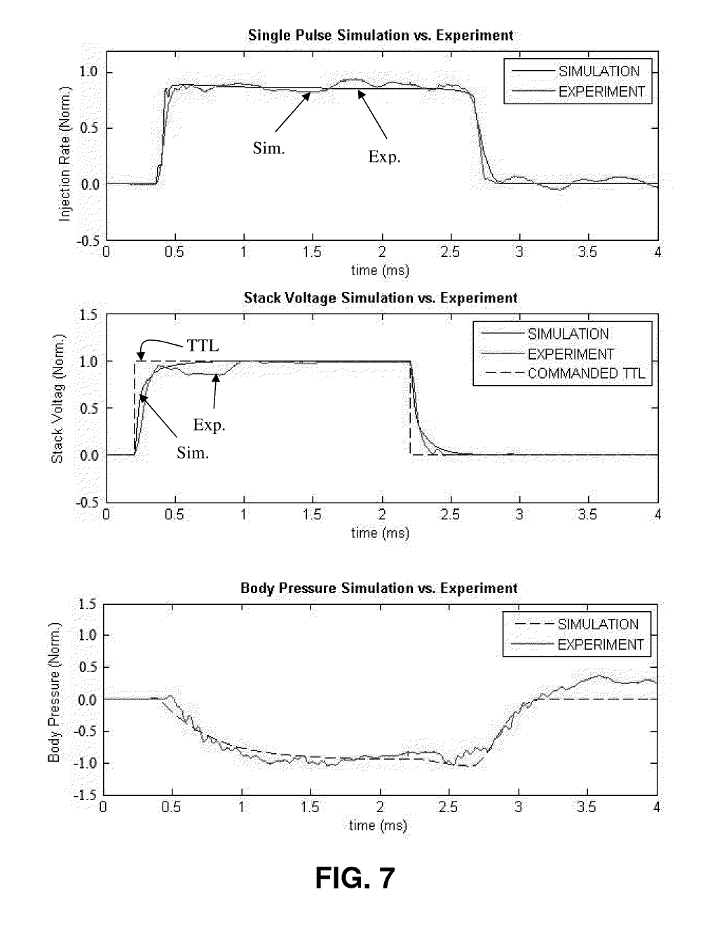

One embodiment of the present invention was used experimentally. An estimator according to FIG. 6 was compared to an open-loop simulation (FIG. 5 utilizing the TTL signals as input) and experimental data for different injection profiles. These results are shown in FIG. 7-21. It is understood that the data shown herein are provided by way of example only, and are not to be construed as limiting in terms of any embodiment.

A single TTL pulse 2 ms in length is sent to the injector driver. The simulation of flow rate, stack voltage, and body pressure are shown below in FIG. 7 as calculated by the simulation model equations represented in FIG. 5 and given by Eq. (2.12) through (2.17).

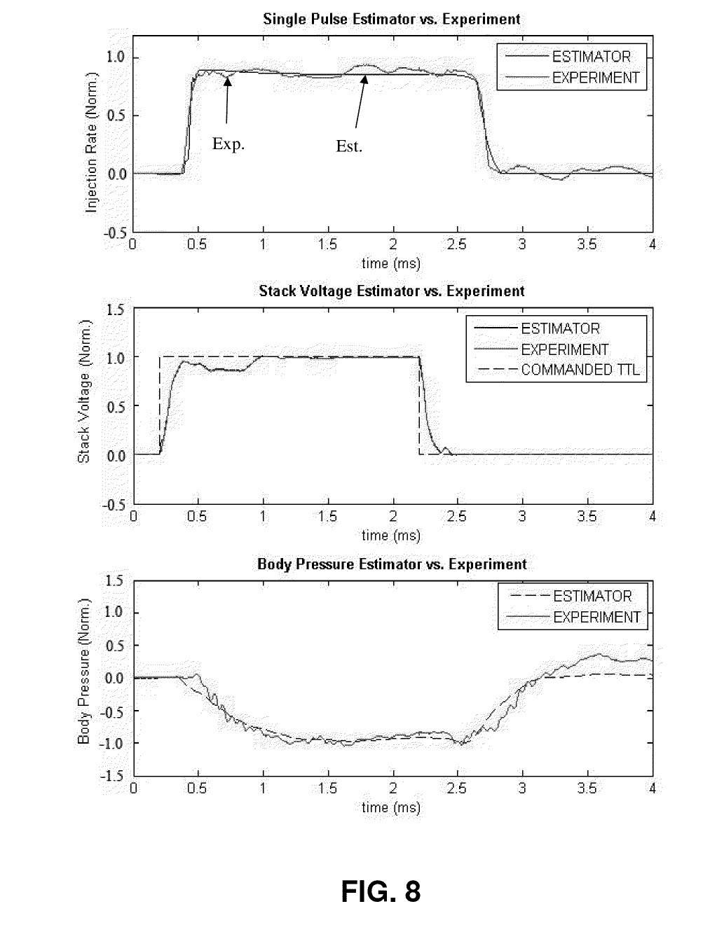

With regards to FIG. 7, for a single pulse, the simulation model (FIG. 5) generally captures the features of flow rate, stack voltage, and body pressure adequately. For comparison, the estimator (FIG. 6 and Eqs. (3.22) through (3.27)) results are shown below in FIG. 8.

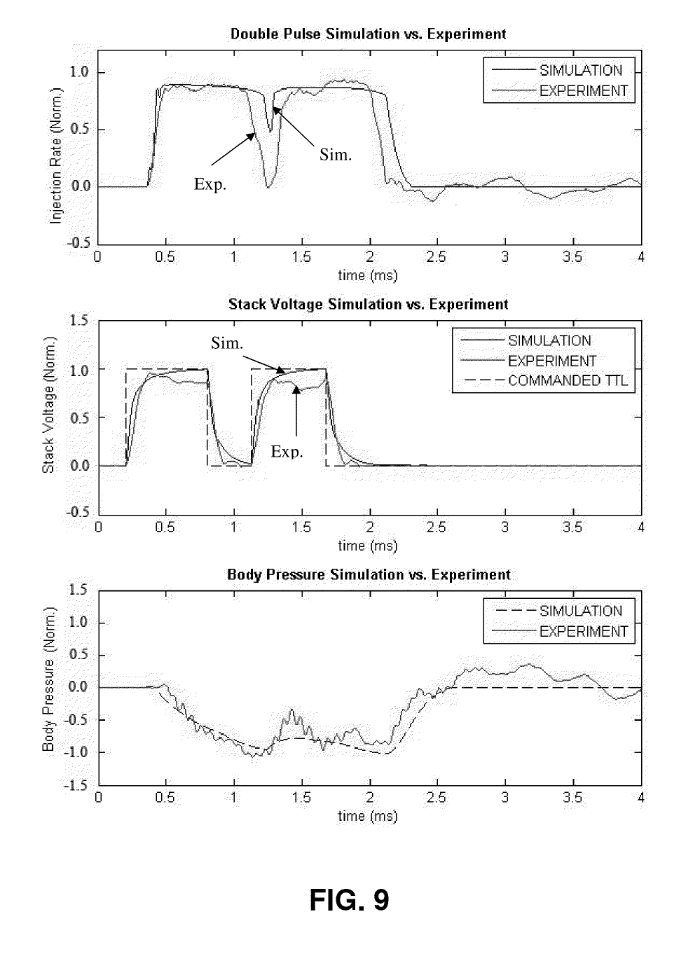

With regards to FIG. 8, the estimator as shown to track stack voltage with feedback estimation. The simulation model comparison for two tightly spaced pulses is shown in FIG. 9.

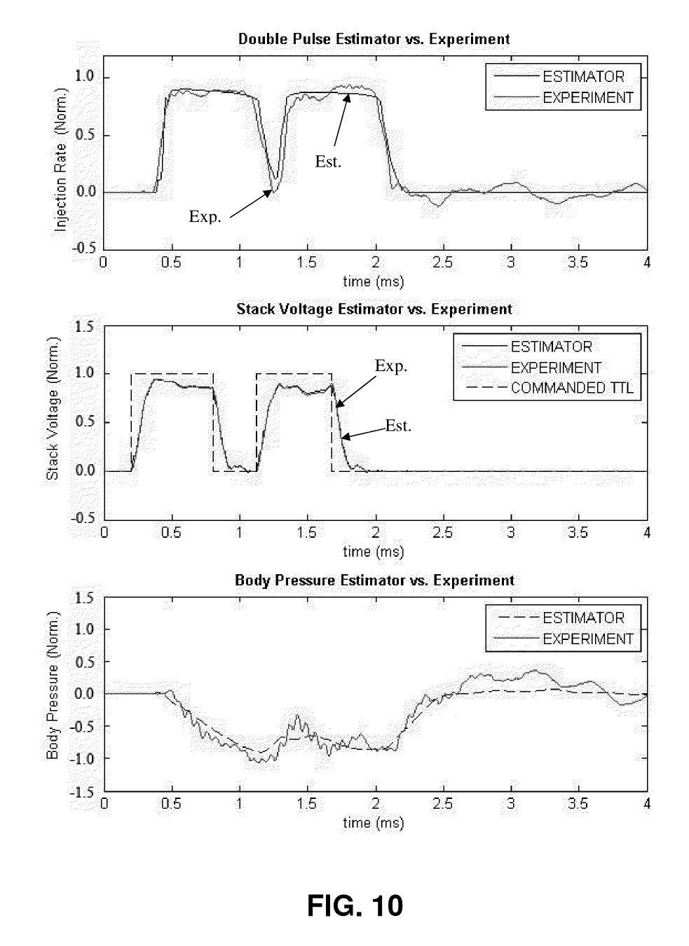

With regards to FIG. 9, an overestimation of stack voltage can result in the type of match shown to the experimental data. FIG. 10 shows the flow estimate when stack voltage is corrected via feedback with the estimator.

With regards to FIG. 10, when the stack voltage estimator is used the state estimates are more consistent with the actual injector response, resulting in improvement in flow rate estimation. The body pressure shows improved tracking with feedback.

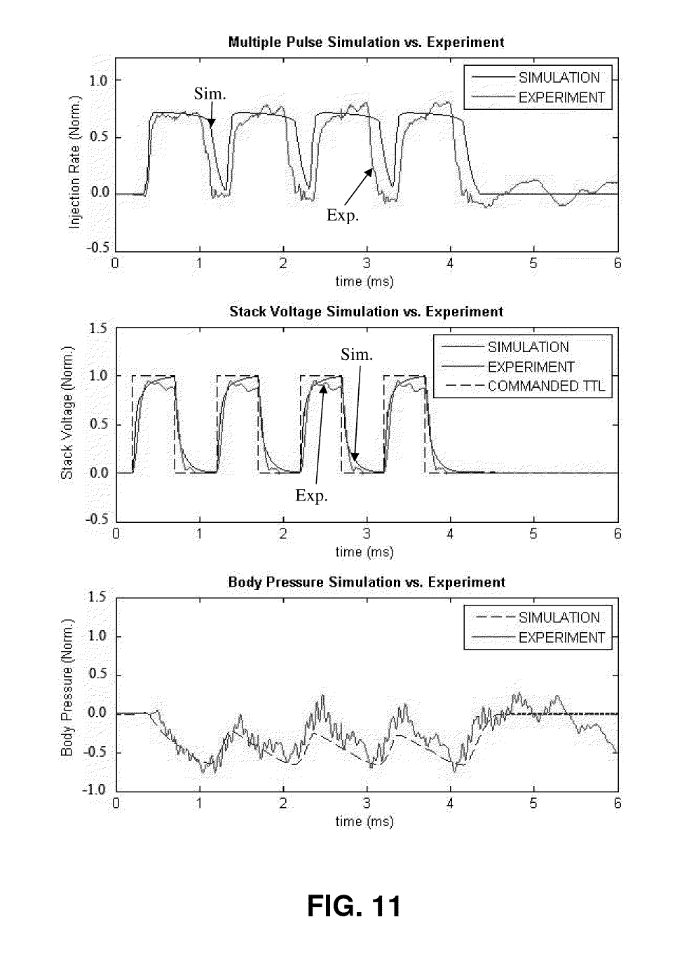

The last example (FIGS. 9 and 10) showed how feedback estimation (FIG. 6) has utility for rapid changes in the commanded voltage. Extending this concept further, FIG. 11 shows a multiple pulse profile run in the simulation model.

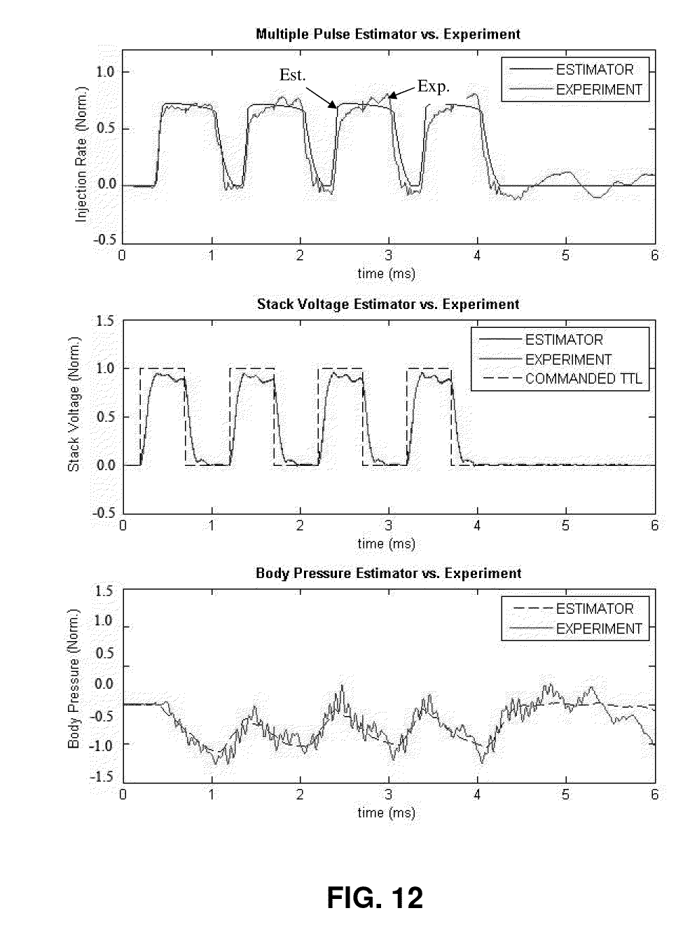

With regards to FIG. 11, a misalignment of the stack voltage appears to cause flow estimation error in a similar fashion to that which occurred in the double pulse case. The error in the stack voltage propagates to the flow rate, which in turn causes misalignment of the body pressure. Feedback estimation is applied below in FIG. 12, demonstrating improvement in the predicted injection rate.

FIG. 12 also shows that the body pressure estimator tracks the body pressure and also filters out high frequency noise.

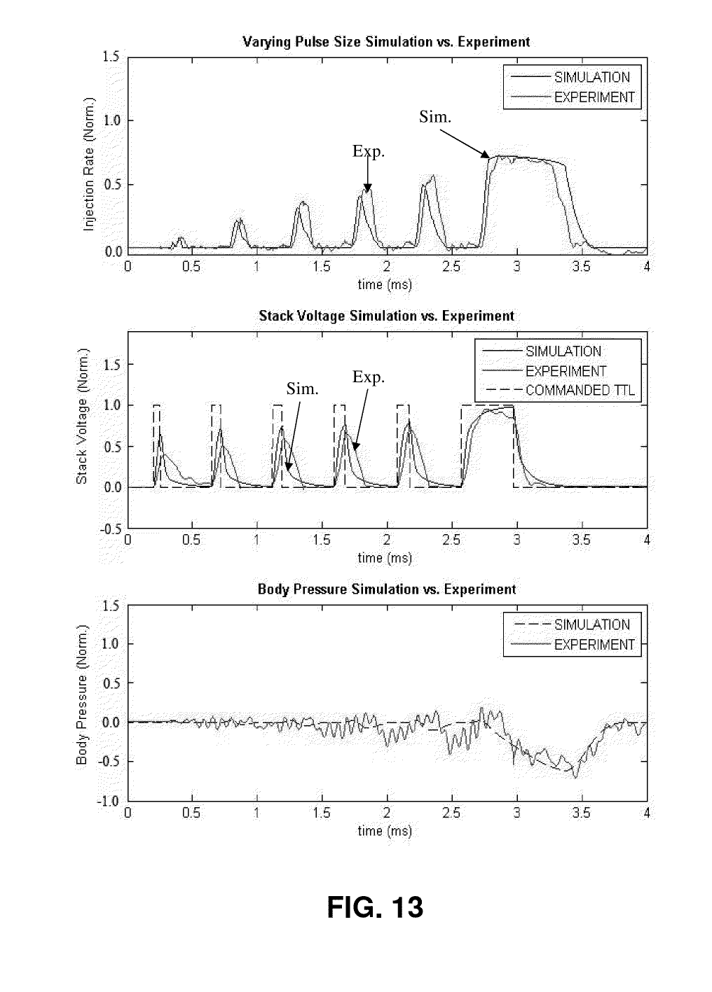

The previous examples showed a variety of pulses of equal size. FIG. 13 shows the simulation model predictions for variable pulses ranging from small to fully open.

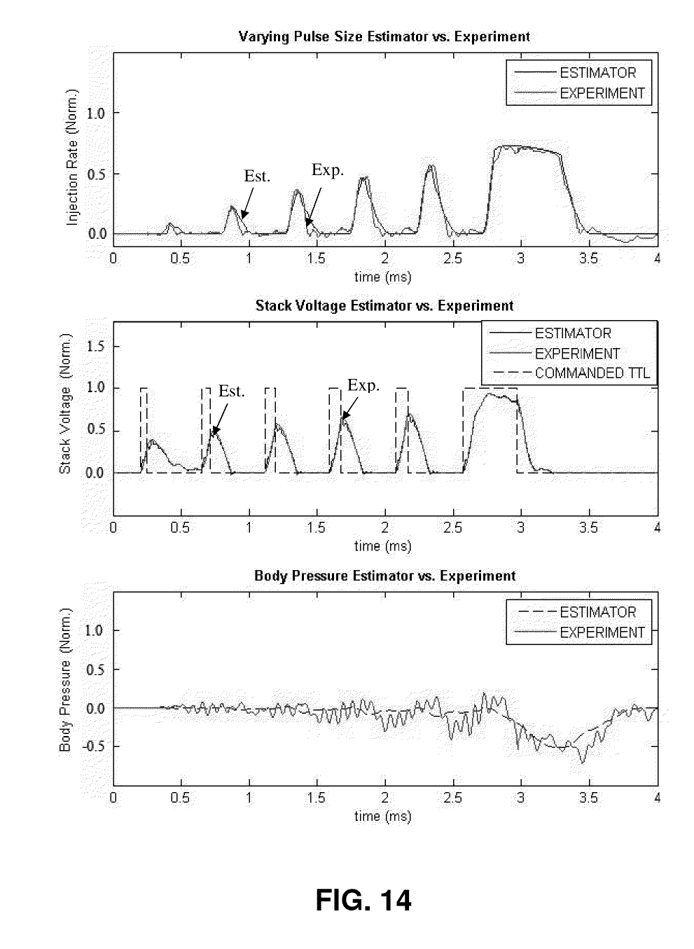

FIG. 13 shows the voltage estimates for short injections. The simulation model results are generally consistent with experimental data. The body pressure shows little deviation due to the small quantity injections. FIG. 14 shows the performance of the estimator with the same profile, exhibiting improvements in the predicted injection rate.

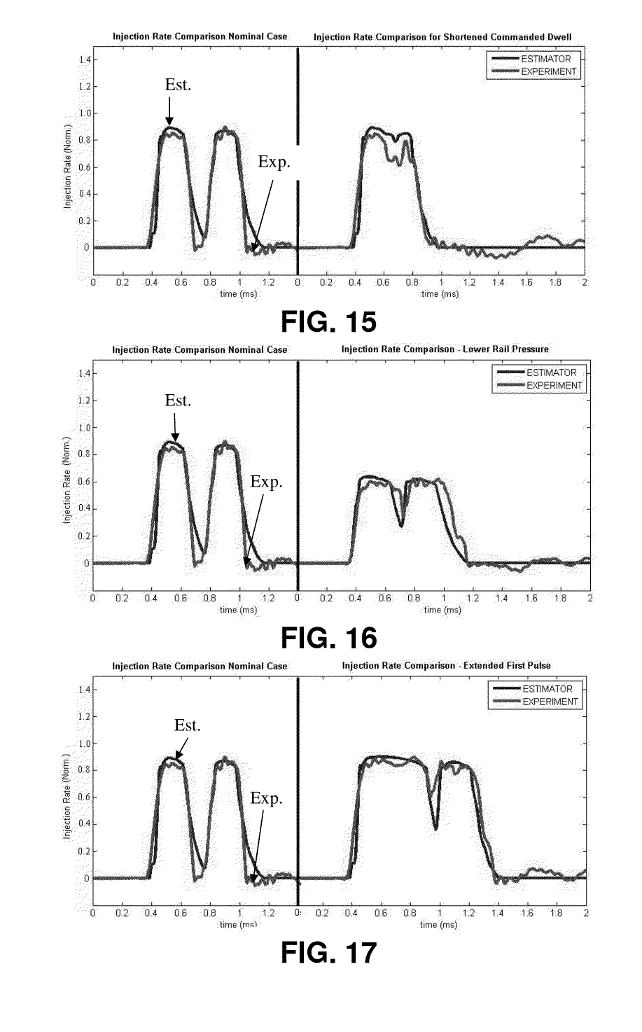

FIG. 15 shows two separate pulses bleeding together when the commanded dwell is reduced. The data in both cases are compared to the estimator in FIG. 15. The estimator does show the expected outcome of two pulses bleeding into a single pulse. FIG. 16 shows the estimator compared to the same profiles in FIG. 2, where lower rail pressure also causes pulse bleeding. The estimator shows the expected behavior of the pulses bleeding into a single pulse when the rail pressure is reduced.

Additional experimental observations (FIG. 3) show that extending the first pulse also causes pulse-to-pulse bleeding. The flow profiles in FIG. 3 are compared to estimator results in FIG. 17. The estimator captures the effect of two pulses bleeding into a single pulse.

An estimator according to one embodiment of the present invention (FIG. 6) is shown to reasonably capture the experimental observations for a variety of cases (FIGS. 8, 10, 12, and 14 through 17) including those exhibiting pulse-to-pulse interaction (FIG. 15 through 17). In addition to having utility in closed-loop control, viewing the estimated (but unmeasured) states of the estimator can help explain the behavior that occurs in the actual system, including pulse-to-pulse interactions. Further, the estimation algorithms shown and described herein can be used for diagnostics of the engine, prognostics of future engine operation, and also for estimating various engine parameters, such as noise, torque, and emissions.

One characteristic of the injector is the relationship between the needle lift, x, and the resistance to flow out of the injector, R_{need}(x). With a direct measurement of the needle lift, one could compare measured flow rate to needle lift and empirically determine this relationship. Another method to determine this relationship is to compare the measured flow rate to the modeled needle lift. If a function can be developed mapping needle lift to flow resistance, and it is repeatable for a variety of profiles and injection pressures, then that function can be used.

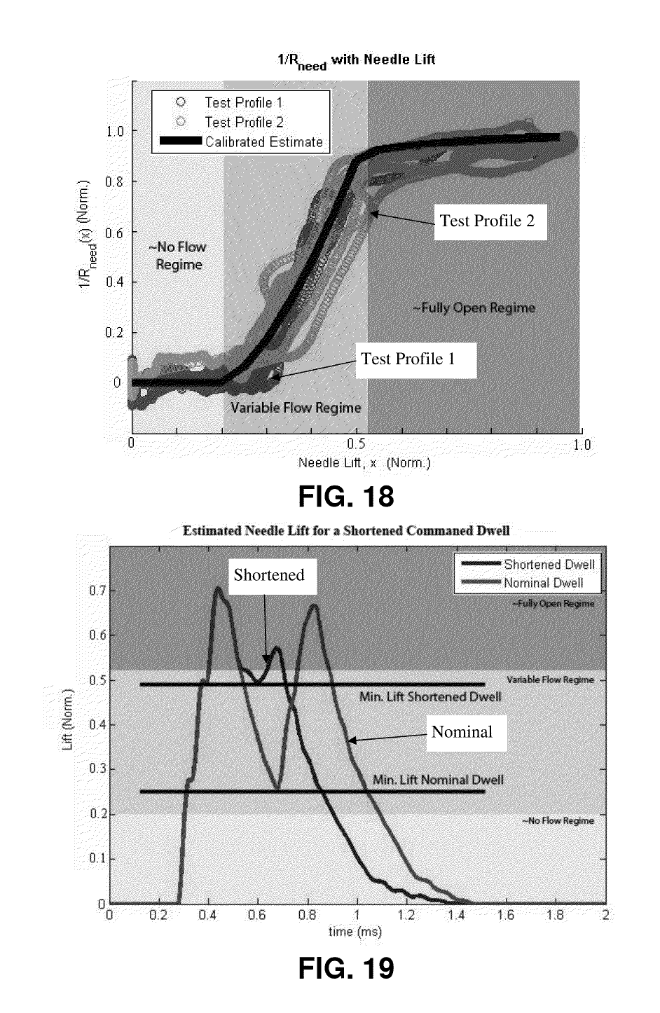

Because resistance goes from infinity when x=0 to fully open as x→∞, it is more convenient to view 1/R_{need}. FIG. 18 shows this plotted for two separate profiles. The cases are at different rail pressures, one of which correlates with the profile shown in FIG. 13, which has a variety of intermediate needle lifts and corresponding flow rates. The other case is a high rail pressure, double pulse profile.

Generally, the measured data falls along a common curve, a (1-1) mapping that can be used in modeling. A “calibrated estimate” line is a mathematically convenient analytic fit of the mapping used in the estimator between needle position, x, and flow resistance, R_{need}(x).

This plot not only provides additional evidence of the reliability of the mathematical models used in the estimator, but also gives insight into how flow is correlated to needle lift. Notice in FIG. 18, the curve is broken into three regions of flow characterization. The leftmost regime appears to indicate that there is a segment of needle lift where flow is sufficiently small and can be assumed to be essentially zero. The next regime, titled ‘variable flow regime’ is where there exists a sensitivity between needle lift and flow resistance. The last regime, labeled ‘fully open regime’ is where resistance appears to saturate, indicating more needle lift results in smaller and smaller incremental increases in flow.

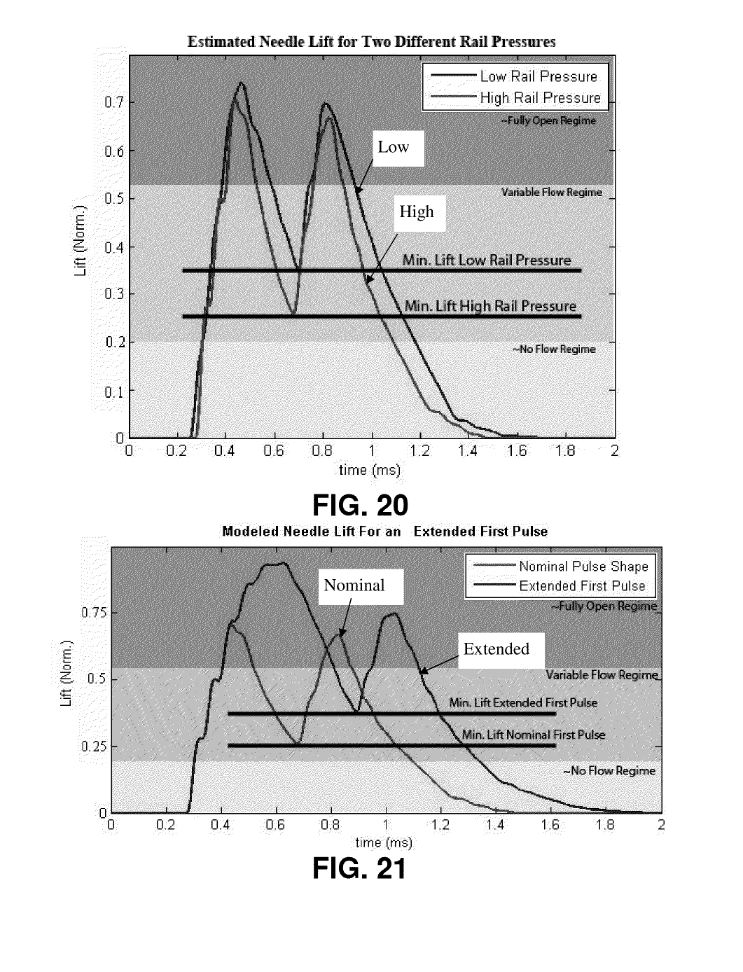

FIG. 15 shows two pulses bleeding together when the commanded dwell is shortened. FIG. 19 shows the estimated needle lifts with the flow regimes from FIG. 18 overlayed. Shortening the commanded dwell will eventually make the needle rise back up before it closes—causing the pulses to mesh into one. FIG. 16 shows the pulse bleeding effect when the rail pressure is lowered. FIG. 20 shows the estimated needle lift for this case.

Marked on the plot are the minimum lifts that occur in between the pulses. When the rail pressure is lower, the minimum lift is slightly higher. Note the regime in which this minimum lift occurs—the variable flow regime. In this regime, the difference between the minimum lifts translates to the flow being almost double at this point—making the two pulses appear to bleed as opposed to being distinct for the low rail pressure case. The experimental point was chosen to have a short dwell, which made the minimum needle lift fall close to the transition between the ‘no flow’ and ‘variable flow’ regimes for the high pressure point. Also notice that because the maximum lift is higher for the low pressure trace, the needle spends more total time in the ‘fully open’ regime for both pulses, making the final flow profile appear to be two extended pulses which bleed into one.

FIG. 17 shows the effect of extending the first pulse in a two pulse series. Where initially in the nominal case there are two distinct pulses, extending the first pulse causes the two pulses to bleed into one. Below, FIG. 21 shows the estimated needle lifts for these two cases with the hypothetical flow regimes overlayed.

Extending the first pulse results in a higher needle lift. As soon as the needle begins to retract it travels a longer stroke to return to the no flow regime, but before it reaches the transition the actuator is commanded to turn back on—lifting the needle back up in the middle of the variable flow regime as opposed to the bottom. The flow rate stays at a higher minimum in between pulses and therefore a bleeding effect is seen in the flow profile.

While the examples given here illustrate these effects for two pulses, they are applicable to a series of pulses strung together. A profile that delivers distinct pulses at one rail pressure may deliver one long pulse at another.

A dynamic estimation of fuel flow out of an injector in some embodiments is calculated rapidly enough that the flow rate can be used as a measurement for a closed-loop control system. The various estimation equation shown herein can be utilized in a real time processor to achieve cycle-to-cycle estimations. Also, a controller is disclosed utilizing the estimation of flow rate to achieve cycle-to-cycle tracking of multiple pulse profiles, specifically the fueling and the dwell time in between injected pulses.

FIG. 22(b) shows a portion of an estimation and control structure for an electronic controller. One particular embodiment of the present invention is demonstrated with a dSPACE® controller. The equation and feedback signals were provided onto the dSPACE platform for real-time execution. Code is executed on a real-time processor by syncing the model time step with a real clock, and as long as all of the executions in one time step of the code can be computed in that amount of time, then real-time computation of states is possible.

While there are a significant number of estimator calculations that require a small time step, making real-time processing more difficult, a fuel injection event takes place on a time scale generally less than about ten milliseconds. For an engine running at 1000 FPM crank speed (500 RPM cam) there are 120 ms in a cycle. Because there is an amount of time in a cycle where the processor has few critical processes, that dead time can be used to compute states for a short window earlier in the cycle when injection occurred. The ND conversions occur during injection at the desired “effective” time step, and real inputs and measurements can be used for estimation. This method can be used for cycle-to-cycle computation of states.

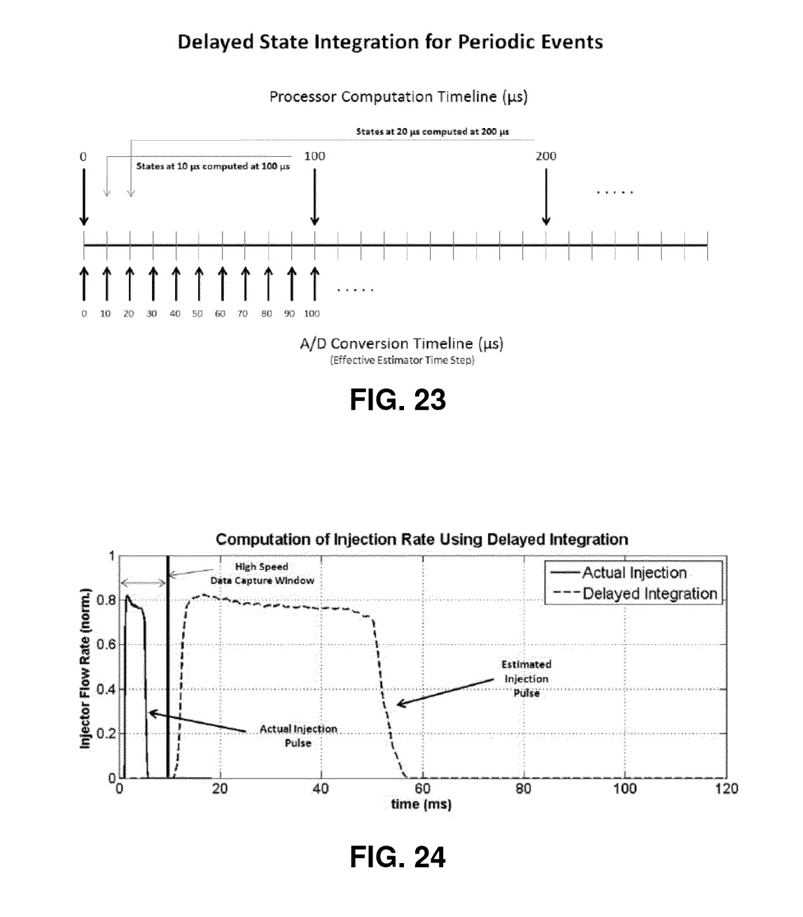

This computational strategy of “delaying” real-time integration is shown graphically in FIG. 23. ND conversions of measurements (TTL signal, stack voltage, and body pressure) take place during a set window at the beginning of a cycle (approx. 10 ms). These values are stored in a temporary memory array for the duration of the cycle. A time step of 100 μs was found to be adequate for the real-time processor used here. Because the “effective” time step is 10 μs, at the first computational period of 100 μs the processor pulls the measurements stored at 10 μs and computes the states. This is repeated for each “effective” time step interval for the entire stored window.

In some embodiments, because computations take place every 10 “effective” time steps, it takes 10 times longer than the event to calculate the states for the whole window. For example, if data is collected for the first 10 ms of an injection event, then it will take 100 ms to calculate the states for that entire window. For cycle-to-cycle control, the engine speed then cannot exceed 1200 RPM crank speed (600 RPM cam). Expanding the speed range can be done by increasing the “effective” model time step (possibly at the expense of accuracy), reducing the real-time processor fundamental time step (may require model simplification), tightening the data collection window, allowing computations across multiple cycles, or using a faster processor. FIG. 24 shows an example pulse for a 1000 RPM crank speed cycle and the output for the estimator. It is appreciated that the timing and engine speeds noted above were used in a specific embodiment, and are not to be construed as limiting on any embodiments of the present inventions.

The injection event takes place during a relatively small portion of cycle (labeled “High Speed Data Capture Window”). The available measurements for estimating the flow rate (characteristics such as TTL signal, stack voltage, and body pressure) are captured and stored during this period at 10 μs intervals. Corresponding computations of estimator states are done at the processor interval of 100 μs using data stored in an array. This creates an estimated flow rate profile where the time domain is scaled by 10. Rescaling the time axis gives the estimate in the proper time domain and allows processing the profile as needed. This can be repeated every cycle allowing for cycle-to-cycle estimation of flow.

While the inventions have been illustrated and described in detail in the drawings and foregoing description, the same is to be considered as illustrative and not restrictive in character, it being understood that only certain embodiments have been shown and described and that all changes and modifications that come within the spirit of the invention are desired to be protected.

What is claimed is:

1. A method of controlling an internal combustion engine, comprising:
providing an internal combustion engine and an electronic controller operating a piezo-electrically actuated fuel injector receiving fuel;
actuating the injector with a first electrical signal from the controller and operating the engine;
measuring the voltage across the piezo-electric actuator during said actuating; and
using the measurement of voltage and calculating a corrected electrical signal by the electronic controller different than the first electrical signal;
actuating the injector with the corrected electrical signal from the controller and modifying the operation of the engine.

2. The method of claim 1 wherein the controller includes a software algorithm relating the time history of the voltage to an estimated time history of fuel injected, and said calculating is with the algorithm.

3. The method of claim 1 which further comprises measuring the pressure of the fuel provided to the fuel injector during said actuating, and said calculating includes using the measurement of pressure.

4. The method of claim 1 wherein the controller includes a software algorithm relating the measured voltage to the quantity of fuel injected, and said calculating is with the algorithm.

5. The method of claim 1 wherein the first electrical signal is adapted and configured to provide two discrete pulses of fuel separated by a first dwell time, and the corrected electrical signal provides a corrected dwell time different than the first dwell time.

6. The method of claim 1 wherein the first signal is adapted and configured to provide a desired injection of fuel, and which further comprises relating the measurement of voltage to an estimated injection of fuel.

7. The method of claim 6 wherein said calculating includes comparing the desired fuel injection to the estimated fuel injected.

8. The method of claim 1 wherein the first electrical signal includes a plurality of discrete pulses, each pulse being less than about ten milliseconds in duration.

9. The method of claim 1 which further comprises estimating the quantity of fuel provided during said actuating and said calculating is in response to said estimating.

10. A method for controlling an internal combustion engine, comprising:
providing an engine, an electronic controller operably connected to an electrically actuatable fuel injector, and a predetermined desired transient input of fuel;
transmitting a first control signal by the controller to the fuel injector actuator and flowing a first transient input of fuel to the engine by the injector;
measuring an input parameter to the fuel injector during the first transient input of fuel;
calculating an estimated transient input of fuel using the measured input parameter;
comparing the estimated transient input of fuel to the desired transient input of fuel;
preparing a second control signal different than the first control signal based on said comparing; and
transmitting the second control signal by the controller to the fuel injector actuator and flowing a second transient input of fuel to the engine by the injector.

11. The method of claim 10 wherein the input parameter is fuel pressure.

12. The method of claim 10 wherein the input parameter is drive voltage.

13. The method of claim 10 wherein the input parameter corresponds to the first control signal as received by the actuator.

14. The method of claim 10 wherein the actuator includes a piezoelectric driver.

15. The method of claim 10 wherein the first control signal is adapted and configured to provide two discrete pulses of fuel during the first transient input of fuel.

16. The method of claim 10 wherein the desired transient input of fuel flow is at least one discrete pulse of fuel having a duration of less than about ten milliseconds.

17. The method of claim 10 wherein the desired transient input of fuel flow is a pair of pulses of fuel, each pulse having a duration of less than about ten milliseconds, and the pulses are separated by a dwell time of less than about ten milliseconds.

18. The method of claim 10 Wherein the electronic controller includes a computer with software, and the software includes a predetermined relationship between an output of an engine and the desired transient input of fuel to the engine.

19. The method of claim 10 wherein the electronic controller includes a computer with software, and the software includes a predetermined relationship between the measured parameter and a representation of the transient response of the electrically actuatable fuel injector.

20. The method of claim 19 wherein the representation includes the electrical transient response of the electrically actuatable fuel injector.

21. The method of claim 19 wherein the representation includes the hydraulic transient response of the electrically actuatable fuel injector.

22. A method of controlling an internal combustion engine, comprising:
providing a source of fuel and a piezoelectrically-actuated fuel injector receiving fuel from the source, the fuel injector including a displaceable piezoelectric actuator and a variable position hydromechanical element providing fuel in response to displacement of the actuator, and an electronic controller having software and providing a time-varying actuation signal;
providing a software representation of a time-based relationship between an actuation signal and the fuel provided by the injector;
applying a first time-varying actuation signal to the injector;
measuring a characteristic of the first signal at the actuator during said applying; and
using the measured characteristic with the software and predicting the time-varying quantity of fuel provided by the injector during said applying.

23. The method of claim 22 wherein the time-based relationship includes a correspondence between the actuation signal and the displacement of the piezoelectric actuator.

24. The method of claim 22 wherein the time-based relationship includes a correspondence between the actuation signal and the position of the needle valve.

25. The method of claim 22 wherein the time-based relationship includes a correspondence between the displacement of the piezoelectric actuator and the position of a needle valve.

26. The method of claim 22 wherein the measured characteristic is voltage.

27. The method of claim 22 wherein the second relationship includes a geometric relationship.

28. The method of claim 22 wherein the third relationship includes a hydraulic relationship.

29. The method of claim 22 wherein the time-based relationship relates the capacitance of the piezoelectric actuator and the force applied by the element on the actuator.

30. The method of claim 22 wherein said using is during operation of the engine and which further comprises utilizing the predicted time-varying quantity of fuel during closed loop control of the engine.

31. A method of controlling an internal combustion engine, comprising:
providing an internal combustion engine and an electronic controller operating an electrically actuated fuel injector receiving fuel;
actuating the injector with a first electrical signal from the controller and operating the engine with a pulse of injected fuel; and
estimating the time-based characteristics of the injected pulse by the controller during said operating.

32. The method of claim 31 wherein said estimating includes relating the actuation signal to the displacement of the electric actuator.

33. The method of claim 31 wherein said estimating includes relating the actuation signal and to the position of a hydromechanical element within the fuel injector.

34. The method of claim 31 wherein said estimating includes relating the displacement of the electric actuator to the position of a hydromechanical element within the fuel injector.

35. The method of claim 31 wherein said estimating includes measuring the voltage applied to the actuator.
